(19) United States
(12) Patent Application Publication
(10) Pub. No.: US 2017/0079219 A1
(43) Pub. Date: Mar. 23, 2017

(54) LAND CLEARING TOOL ASSEMBLY WITH A DEPTH CONTROL RING AND DRUM ASSEMBLY

(71) Applicant: Fecon, Inc., Lebanon, OH (US)

(72) Inventors: Jeffrey Thomas Stanley, Lebanon, OH (US); Tyler Rand Smith, Lebanon, OH (US); Ryan Taylor Bricker, Lebanon, OH (US)

(21) Appl. No.: 15/253,209

(22) Filed: Aug. 31, 2016

Related U.S. Application Data
(60) Provisional application No. 62/212,397, filed on Aug. 31, 2015.

(51) Int. Cl. A01G 23/00; B02C 18/18

(52) U.S. Cl. CPC A01G 23/00; B02C 18/18

(57) ABSTRACT

A bite control ring assembly includes a depth control ring having a first end, a second end opposite the first end, and a gap disposed between the first and second ends; a tool holder having a capture joint and a tool holder interface opposite the capture joint, wherein the first end of the depth control ring is received within the capture joint; and a cutting tool having a cutting tool interface and a cutting surface disposed on a side of the cutting tool opposite the cutting tool interface, wherein the tool holder interface includes a V-shaped surface and the cutting tool interface includes a V-shaped surface that has a reciprocal shape to the tool holder interface such that the tool holder interface receives the cutting tool interface.

### TECHNICAL FIELD

The present specification generally relates to a rotor assembly and method for clearing, cutting, grinding, mulching, and or shredding vegetation, earthen and, more specifically, a bite control rotor assembly and method with a rotating drum assembly having one or more tapered teeth, v-shaped tools, and depth control rings.

### BRIEF DESCRIPTION OF THE DRAWINGS

The embodiments set forth in the drawings are illustrative in nature and not intended to limit the subject matter defined by the claims. The following detailed description of the illustrative embodiments can be understood when read in conjunction with the following drawings, where like structure is indicated with like reference numerals and in which:

FIG. 1 depicts a left front perspective view of a bite control rotor (BCR) drum assembly according to one or more embodiments shown and described herein;

FIG. 2 depicts a left side elevational view of the BCR drum assembly of FIG. 1;

FIG. 3 depicts a right side elevational view of the BCR drum assembly of FIG. 1;

FIG. 4 depicts a front elevational view of the BCR drum assembly of FIG. 1;

FIG. 5 depicts a back elevational view of the BCR drum assembly of FIG. 1;

FIG. 6 depicts a left side elevational view of the BCR drum assembly of FIG. 1 that includes a single BCR;

FIG. 7 depicts a left front perspective view of a BCR separated from the BCR drum assembly of FIG. 1;

FIG. 8 depicts a right rear perspective view of the BCR separated from the BCR drum assembly of FIG. 1;

FIG. 9 depicts a left front perspective view of a cutting assembly of a BCR separated from the BCR drum assembly of FIG. 1;

FIG. 10 depicts an exploded, left front view of the cutting assembly of FIG. 9;

FIG. 11 depicts an exploded, left side elevational view of the cutting assembly of FIG. 9;

FIG. 12 depicts an exploded, top view of the cutting assembly of FIG. 9;

FIG. 13 depicts an exploded, bottom view of the cutting assembly of FIG. 9;

FIG. 14 depicts a left front perspective view of a tool holder of the cutting assembly of FIG. 9;

FIG. 15 depicts a left front perspective view of a cutting tool of the cutting assembly of FIG. 9;

FIG. 16 depicts a left side elevational view of the cutting tool of FIG. 15;

FIG. 17 depicts a right side elevational view of the cutting tool of FIG. 15;

FIG. 18 depicts a front elevational view of the cutting tool of FIG. 15;

FIG. 19 depicts a back elevational view of the cutting tool of FIG. 15;

FIG. 20 depicts a top view of the cutting tool of FIG. 15;

FIG. 21 depicts a bottom view of the cutting tool of FIG. 15;

FIG. 22 depicts a left front perspective view of another exemplary cutting tool of the cutting assembly of FIG. 9;

FIG. 23 depicts a left side elevational view of the exemplary cutting tool of FIG. 22;

FIG. 24 depicts a right side elevational view of the exemplary cutting tool of FIG. 22;

FIG. 25 depicts a front elevational view of the exemplary cutting tool of FIG. 22;

FIG. 26 depicts a back elevational view of the exemplary cutting tool of FIG. 22;

FIG. 27 depicts a top view of the exemplary cutting tool of FIG. 22;

FIG. 28 depicts a bottom view of the exemplary cutting tool of FIG. 22;

FIG. 29 depicts a left front perspective view of another exemplary cutting tool of the cutting assembly of FIG. 9;

FIG. 30 depicts a left side elevational view of the exemplary cutting tool of FIG. 29;

FIG. 31 depicts a right side elevational view of the exemplary cutting tool of FIG. 29;

FIG. 32 depicts a front elevational view of the exemplary cutting tool of FIG. 29;

FIG. 33 depicts a back elevational view of the exemplary cutting tool of FIG. 29;

FIG. 34 depicts a top view of the exemplary cutting tool of FIG. 29;

FIG. 35 depicts a bottom view of the exemplary cutting tool of FIG. 29;

FIG. 36 depicts a left front perspective view of another exemplary cutting tool of the cutting assembly of FIG. 9;

FIG. 37 depicts a left side elevational view of the exemplary cutting tool of FIG. 36;

FIG. 38 depicts a right side elevational view of the exemplary cutting tool of FIG. 36;

FIG. 39 depicts a front elevational view of the exemplary cutting tool of FIG. 36;

FIG. 40 depicts a back elevational view of the exemplary cutting tool of FIG. 36;

FIG. 41 depicts a top view of the exemplary cutting tool of FIG. 36;

FIG. 42 depicts a bottom view of the exemplary cutting tool of FIG. 36;

FIG. 43 depicts a left front perspective view of another exemplary cutting tool of the cutting assembly of FIG. 9;

FIG. 44 depicts a left side elevational view of the exemplary cutting tool of FIG. 43;

FIG. 45 depicts a right side elevational view of the exemplary cutting tool of FIG. 43;

FIG. 46 depicts a front elevational view of the exemplary cutting tool of FIG. 43;

FIG. 47 depicts a back elevational view of the exemplary cutting tool of FIG. 43;

FIG. 48 depicts a top view of the exemplary cutting tool of FIG. 43; and

FIG. 49 depicts a bottom view of the exemplary cutting tool of FIG. 43.

### DETAILED DESCRIPTION

The following text sets forth a broad description of numerous different embodiments of the present disclosure. The description is to be construed as illustrative only and does not describe every possible embodiment since describing every possible embodiment would be impractical, if not impossible, and it will be understood that any feature, characteristic, component, composition, ingredient, product, step or methodology described herein can be deleted, combined with or substituted for, in whole or part, any other feature, characteristic, component, composition, ingredient, product, step or methodology described herein. Numerous alternative embodiments could be implemented, using either current technology or technology developed after the filing date of this patent, which would still fall within the scope of the claims. All publications and patents cited herein are incorporated herein by reference.

As used herein, the term “couple” means to connect, attach, fasten, and/or join to members or parts together, whether fixedly, permanently, detachably, and/or in a fashion that the parts are immovable or movable relative to one another. As used throughout, the term “substance” and its derivations may be, but is not limited to, vegetation (e.g., trees, brush, etc.), soil or other earthen substances (e.g., clay), rock, asphalt, concrete, rock grind, cut, mulch mill, soil mixing, building material (demolition purposes), bricks, and the like. The material from the substance may be parts of the substance that is cut away by the cutting tool 40.

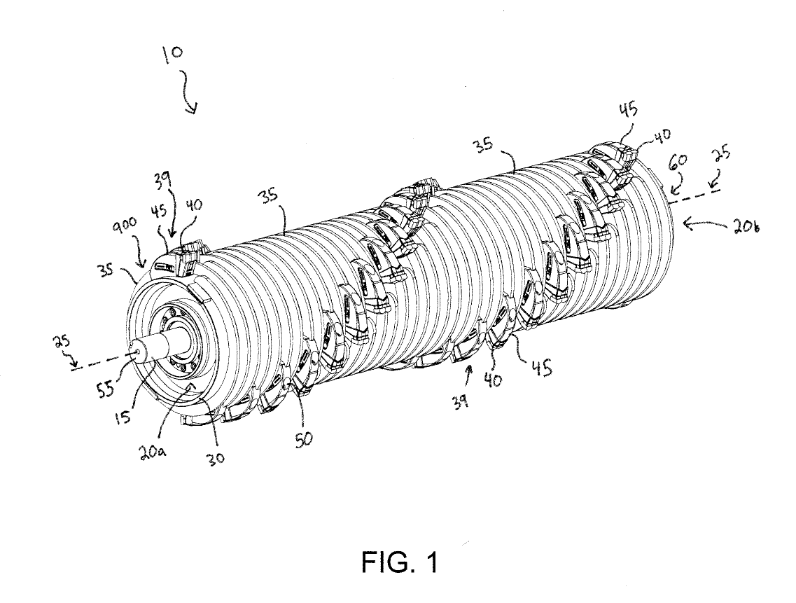

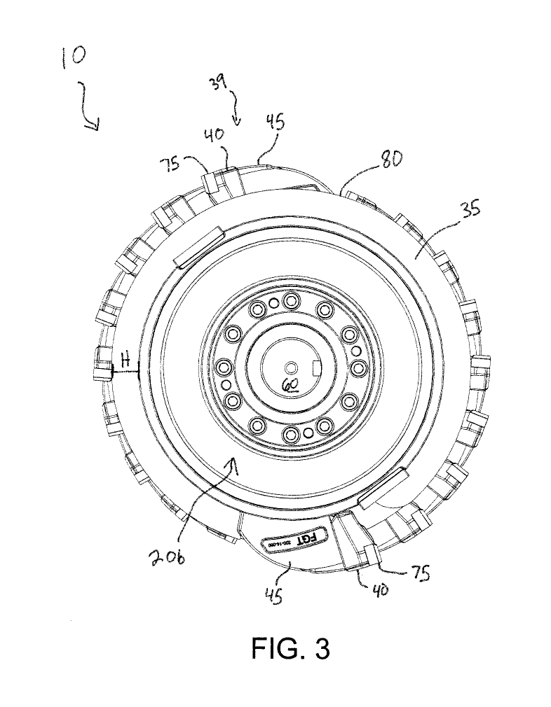

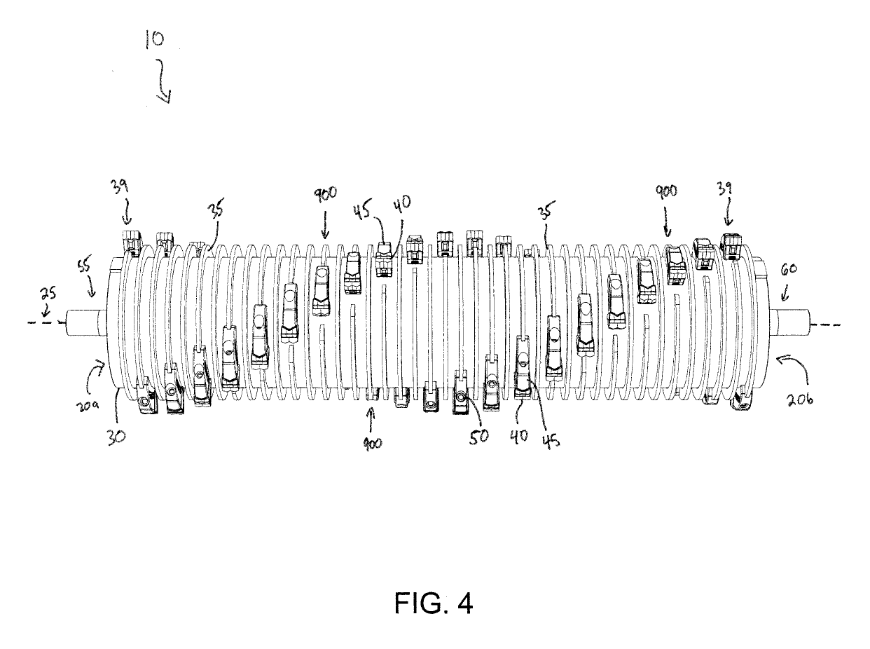

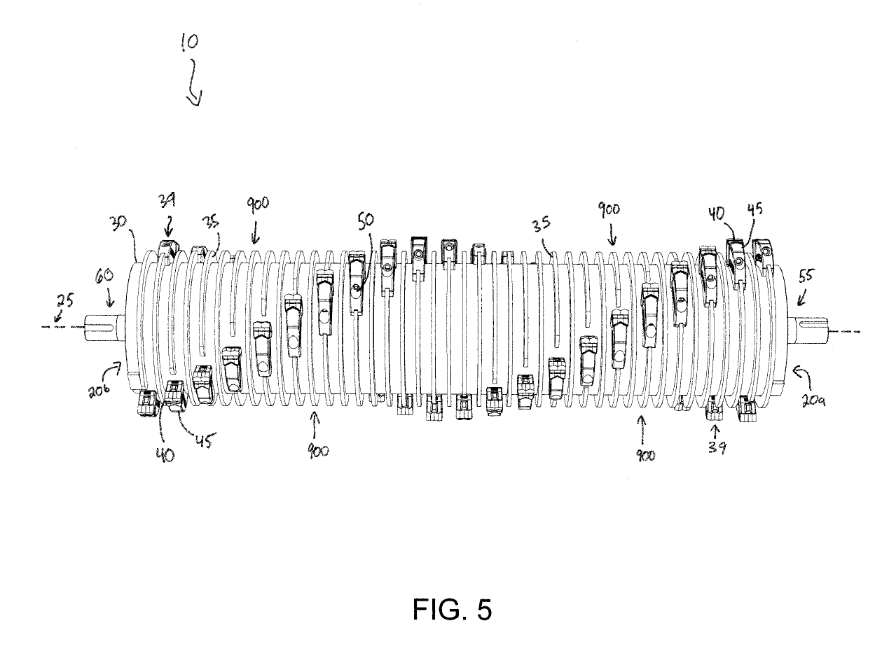

Referring to FIGS. 1-6, the BCR drum assembly 10 includes a shaft 15, a first hub assembly 20a, a second hub assembly 20b, an outer drum shell 30, and one or more bite control rotors (“BCR”) 900. The BCR drum assembly 10 is constructed to be fixedly or detachably coupled to a vehicle, a tractor, a skid-steer, a land clearing machine, and/or any other conventional or yet-to-be developed machinery to be used to clear, cut, grind, mulch, and/or shred a variety of substances. For example, in some embodiments, the BCR drum assembly 10 is constructed to be fixedly or detachably coupled to the vehicles, tractors, skid-steers, land clearing machines, and other machinery described in commonly-owned U.S. Pat. No. 8,540,033, which is hereby incorporated by reference herein. It should also be appreciated that the BCR drum assembly 10, or any of the components thereof (e.g., the depth control ring 35, the cutting tool 40, the tool holder 45, etc.), may be embodied as or otherwise include the cutting tools, tool holders, or any other component shown and described in commonly-owned U.S. Pat. No. 8,540,033.

The first hub assembly 20a and the second hub assembly 20b both include bearings and/or other rotational elements to allow the BCR drum assembly 10 to rotate around a central shaft axis 25 as conventionally known and available. The shaft 15 is coupled to the first hub assembly 20a and the second hub assembly 20b and may be disposed along the central axis 25 between the first hub assembly 20a and the second hub assembly 20b. The first hub assembly 20a is coupled at or near a first end 55 of the shaft 15 and the second hub assembly 20b is coupled at or near a second end 60 of the shaft 15, opposite the first end.

The first hub assembly 20a is also coupled to a first end of the outer drum shell 30 and the second hub assembly 20b is coupled to a second end of the outer drum shell 30, opposite the first end of the drum shell 30. In some embodiments, the shaft 15 may be a right shaft and a left shaft where each shaft is coupled to a respective hub assembly (20a or 20b) and the right shaft is not coupled to the left shaft in any way. The outer drum shell 30 provides a circular foundation for one or more BCRs 900 to be disposed thereon and therearound and/or coupled thereto. The outer drum shell 30 center extends along the central axis 25 of the shaft 15. In one embodiment, the first end 55 of the shaft 15 and the second end 60 of the shaft 15 may be constructed to detachably couple the BCR drum assembly 10 to a vehicle, a tractor, a skid-steer, a land clearing machine, and/or any other machinery. The first end 55 and the second end 60 may include a notch or other key hole to either prevent the rotation of the shaft 15 or alternately to provide a coupling mechanism to impart a rotation to the shaft 15 and thereby rotate the BCR drum assembly 10.

As shown in FIGS. 1-5, the BCR drum assembly 10 comprises a plurality of BCRs 900 spaced apart from each other along the central shaft axis 25 of the BCR drum assembly 10. The plurality of BCRs 900 may be spaced apart an equal distance from each other across the outer drum shell 30 along the central shaft axis 25 or, alternatively, spaced apart an unequal distance from each other across the outer drum shell 30 along the axis 25. As shown, each of the BCRs 900 along the BCR drum assembly 10 are also rotationally positioned about the circumference of the drum shell 30 out-of-phase a specific number of degrees relative to each adjacent BCR 900.

For example, in an embodiment, if only four BCRs 900 are coupled to the outer drum shell 30, each BCR 900 would be positioned in about 90 degree intervals about the circumference of the outer drum shell 30. Thus, each BCR 900 would be 90 degrees out-of-phase with its neighboring or adjacent BCR(s). In another example, if eight BCRs 900 are coupled to the outer drum shell 30, each BCR would be positioned in about 45 degree intervals about the circumference of the outer drum shell 30. Thus, each BCR 900 would be 45 degrees out-of-phase with its neighboring or adjacent BCR(s). In the embodiment shown in FIGS. 1-5, forty-two BCRs 900 are positioned about every 8.5 degrees about the circumference of the outer drum shell 30 and thus are about 8.5 degrees out-of-phase from each adjacent BCR 900.

In another embodiment, a first BCR 900a having a first tooth 75 is positioned and coupled to the outer drum shell 30 adjacent to the first end 55 of the shaft 15, a second BCR 900b having a second tooth 75 is positioned and coupled to the outer drum shell 30 such that the second tooth 75 is staggered by about 0 degrees of angular rotation to about 20 degrees of angular rotation about the circumference of the drum shell 30 relative to the first tooth 75, a third BCR 900c having a third tooth 75 is positioned and coupled to the outer drum shell 30 such that the third tooth 75c is staggered by about 0 degrees of angular rotation to about 20 degrees of angular rotation about the circumference of the drum shell 30 relative to the second tooth 75, a fourth BCR 900d having a fourth tooth 75 is positioned and coupled to the outer drum shell 30 such that the fourth tooth 75 is staggered by about 0 degrees of angular rotation to about 20 degrees of angular rotation about the circumference of the drum shell 30 relative to the third tooth 75, a n^{th} BCR 900n having a n^{th} tooth 75 is positioned and coupled to the outer drum shell 30 such that the n^{th} tooth 75 is staggered by about 0 degrees of angular rotation to about 20 degrees of angular rotation about the circumference of the drum shell 30 relative to the n^{th}-1 tooth, and so on. In other embodiments, each of the BCRs 900 may be randomly staggered relative to each other. Other BCR 900 and/or tooth arrangements may be set up and are contemplated herein.

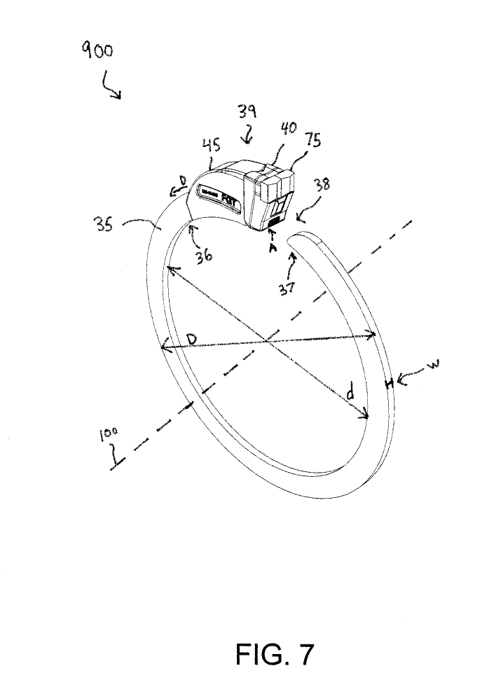

In some embodiments, each BCR 900 includes a depth control ring 35 and a cutting assembly 39. In such embodiments, each cutting assembly 39 includes a tool holder 45 and a cutting tool 40 either fixedly or detachably coupled to the tool holder 45. The tool holder 45 of each cutting assembly 39 may be coupled to the depth control ring 35. Each cutting assembly 39 may also include a fastening device 50 that detachably connects the cutting tool 40 to the tool holder 45. An inner diameter (d) (see FIG. 7) of the depth control ring 35 may be disposed about the outer drum shell 30. In some embodiments, the depth control ring 35 is fixedly coupled (e.g., welded, epoxied, screwed, bolted, braised, bonded, etc.) to the outer drum shell 30. In other embodiments, the depth control ring 35 is detachably coupled to the outer drum shell 30 through conventional and/or yet-to-be developed mechanisms. In either case, the depth control ring 35 extends radially from the outer drum shell 30 at a depth height (H). The depth height (H) of the depth control ring 35 may be varied to provide a desired depth between the tooth 75 and a peripheral edge of the depth control ring 35 and/or the surface of the outer drum shell 30. For example, a first BCR drum assembly 10 may have a plurality of BCRs 900 having a plurality of depth control rings 35 having a first depth height (H₁) and, a second BCR drum assembly 10 (not shown) may have a plurality of BCRs 900 having a plurality of depth control rings 35 having a second depth height (H₂) that is different from the first depth height (H₁). In the illustrative embodiment, the depth height (H) of the depth control ring 35 is less than the overall height (not shown) of the cutting assembly 39. For example, in some embodiments, the depth height (H) of the depth control ring 35 is less than or equal to half of the overall height of the cutting assembly 39 when installed. It should be appreciated, however, that the depth height (H) of the depth control ring 35 can be less than, greater than, or equal to any other partial height of the cutting assembly 39 when installed.

In another embodiment, a BCR drum assembly 10 may include a plurality of BCRs 900 disposed across the outer shell drum 30. In such embodiment, each BCR 900 includes a depth control ring 35 having a specific depth height (H) that may or may not be the same as the other BCRs 900 disposed along the outer shell drum 30. The depth height (H) of each depth control ring 35 may be chosen to provide certain arrangements to provide specific operational dynamics and/or benefits. For example, a BCR drum assembly 10 may have one or more BCRs 900 having a depth control ring 35 having a first depth height (H₁) and, one or more BCRs 900 having a depth control ring 35 having a second depth height (H₂) that is different from the first depth height (H₁).

In some embodiments, a kit may include a first BCR 900 having a first depth control ring 35 having a first depth height (H₁) and, a second BCR 900 having a second depth control ring 35 having a second depth height (H₂) that is different from the first depth height (H₁). In other embodiments, a kit may include a first BCR drum assembly 10 that includes a plurality of BCRs 900 having a plurality of depth control rings 35 having a first depth height (H₁) and, a second BCR drum assembly 10 (not shown) that includes a plurality of BCRs 900 having a plurality of depth control rings 35 having a second depth height (H₂) that is different from the first depth height (H₁). The first BCR drum assembly 10 and second BCR drum assembly 10 (not shown) of the kit are constructed to be interchangeably connectable to a vehicle, a tractor, a skid-steer, a land clearing machine, and/or any other conventional or yet-to-be developed machinery.

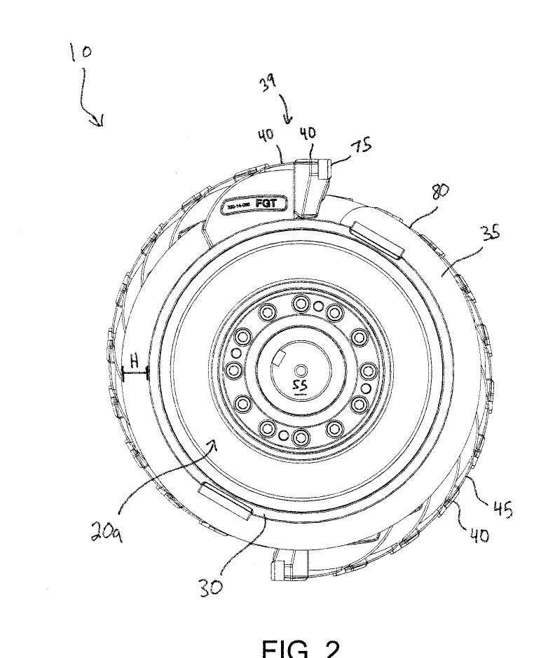

Referring specifically to FIGS. 2, 3, and 6, the cutting tool 40 may include a tooth 75 (or multiple teeth 75) that extends or protrudes beyond the circular plane 80 defined by the peripheral edge of the depth control ring 35. The BCR drum assembly 10 is constructed to provide a maximum depth of penetration (M) into a substance (not shown). The maximum depth of penetration (M) is defined as the distance between the radially, outer-most point 290 of the tooth 75 (or teeth) and the circular plane 80 defined by the peripheral edge of the depth control ring 35 of each BCR 900. It should be appreciated that, in some embodiments, the point 290 may also be defined as the radially, outer-most edge, surface, and/or vertex of the tooth 75 (or teeth). The BCR 900 and components thereof (e.g., the depth control rings 35, etc.) are coaxial with the central shaft axis 25. The circular plane 80 may be defined by the peripheral edge of the depth control ring 35, or in other embodiments, it may be defined by peripheral surface of the outer drum shell 30. The maximum depth of penetration (M) may be modified by either increasing the height that the tooth 75 (or teeth 75) of the cutting tool 40 extends from the outer drum 30 or by decreasing the depth height (H) of the depth control ring 35. The tooth 75 may have its height increased by adding a spacer (not shown) to the area between tool holder 45 and the outer drum shell 30. In some embodiments, the maximum depth of penetration (M) may range from about 0.25 inches to about 8 inches. In another example, the maximum depth of penetration (M) may range from about 0.5 inches to about 6 inches. In yet another example, the maximum depth of penetration (M) may range from about 0.75 inches to about 4.5 inches. And, in another example, the maximum depth of penetration (M) may range from about 1.5 inches to about 3 inches. In one example, the maximum depth of penetration (M) is 2 inches.

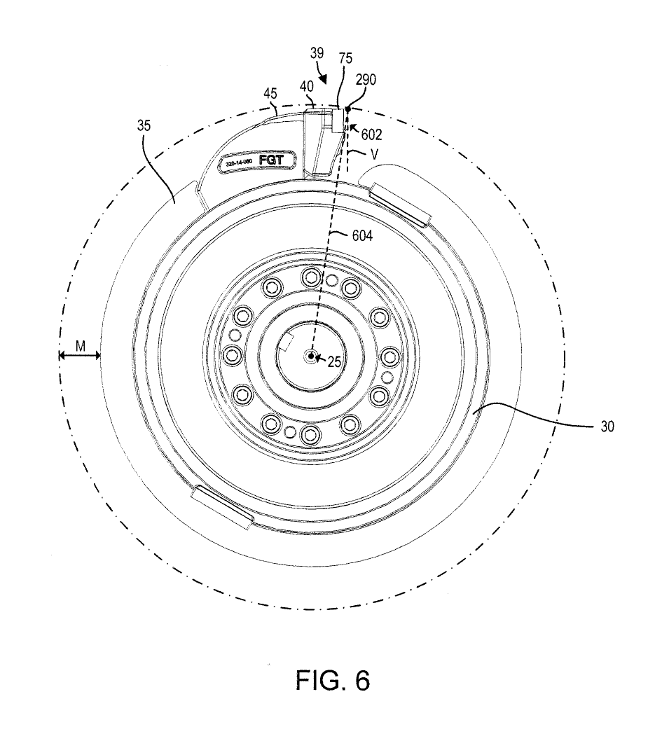

Referring now to FIGS. 6-8, one embodiment of a single BCR 900 is shown. A central ring axis 100 defines the center axis of each BCR 900 such that when each BCR 900 is disposed upon and/or coupled to the outer drum shell 30, the central ring axis 100 is coaxially-aligned with the central shaft axis 25. The cutting tool 40, tool holder 45, and fastening device 50 (e.g., the cutting assembly 39) of BCR 900 may be aligned and/or centered about the central ring axis 100. In some embodiments, the central ring axis 100 may also provide the benchmark for which the evenly spacing of the one or more BCRs 900 is measured and determined. In some embodiments, the depth control ring 35, the cutting tool 40, the tool holder 45, and the fastening device 50 are separate and distinct elements that. In another embodiment, the cutting tool 40, the tool holder 45, and the depth control ring 35 are one integral piece and thus the fastening device 50 is not be needed. In yet another embodiment, the depth control ring 35 and the tool holder 45 are one integral piece and the cutting tool 40 is coupled to the tool holder 45 by the fastening device 50.

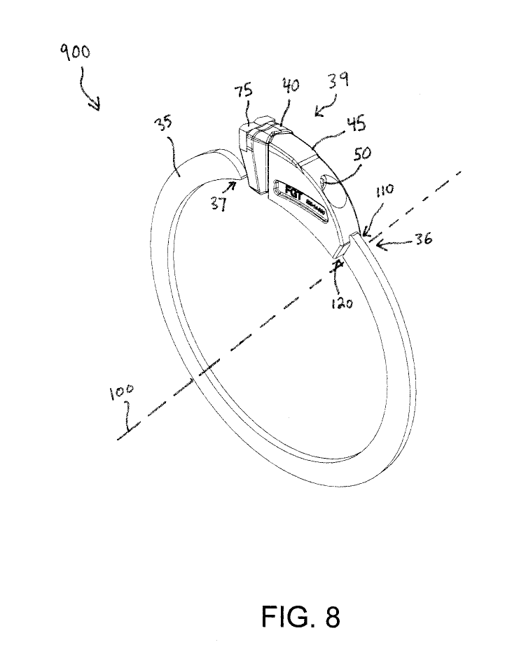

Referring still to the illustrative embodiment shown in FIGS. 7 and 8, the depth control ring 35 is generally an annular disc having an inner diameter (d) and an outer diameter (D). The depth control ring 35 extends from a first end 36 to a second end 37 such that a gap 38 is formed between the first and second ends 36 and 37, respectively. When the depth control ring 35 is installed and coupled to the outer drum shell 30, the inner diameter (d) is abutted and engaged against the outer drum shell 30 and the depth control ring 35 forms a continuous ring about the outer drum shell 30 from its first end 36 to its second end 37. The depth control ring 35 has a width (w), which can be varied to any desired thickness. At the first end 36, the depth control ring 35 may further include an upper ridge 110 and a back ridge 120. The upper ridge 110 may be constructed at such an angle to engage the tool holder 45 and, optionally, provide a force vectored radially-inward towards the central shaft axis 25 and/or the central ring axis 100. In this illustrative embodiment, the upper ridge 110 may be constructed to counter or mitigate the upward forces or movements (shown, for example, as an arrow A in FIG. 7) which would possibly pull the tool holder 45 away from the outer drum shell 30 and, over time, serve to fatigue and/or break the BCR drum assembly 10 or components thereof. The back ridge 120 may also be constructed to engage the tool holder 45 such that it may optionally mitigate or prevent the tool holder 45 from moving in direction D (as shown, for example, in FIG. 7) when the cutting tool 40 engages substances during operation as illustratively provided above.

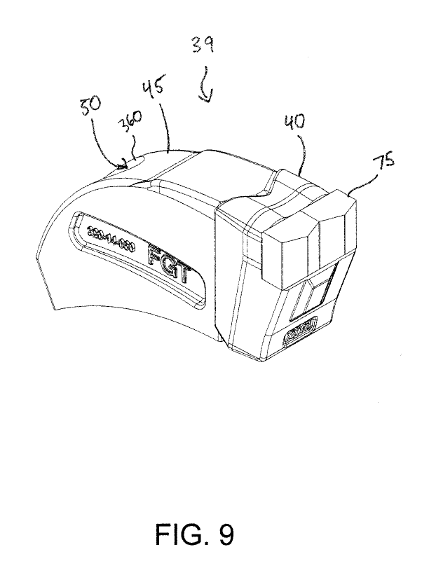

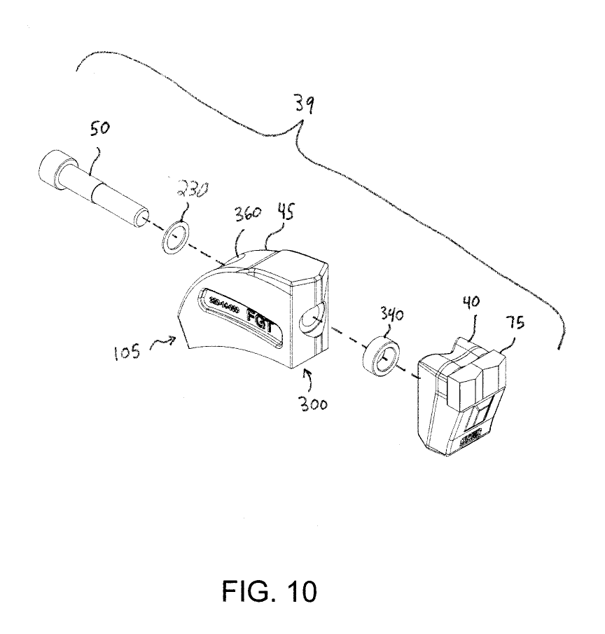

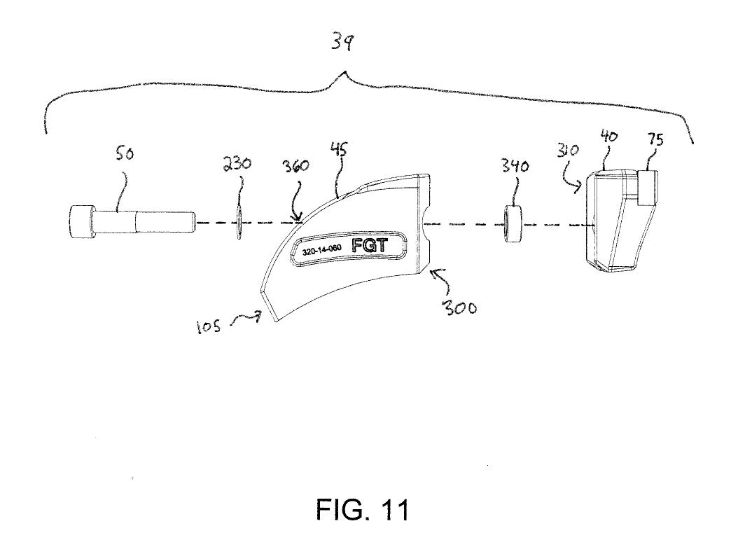

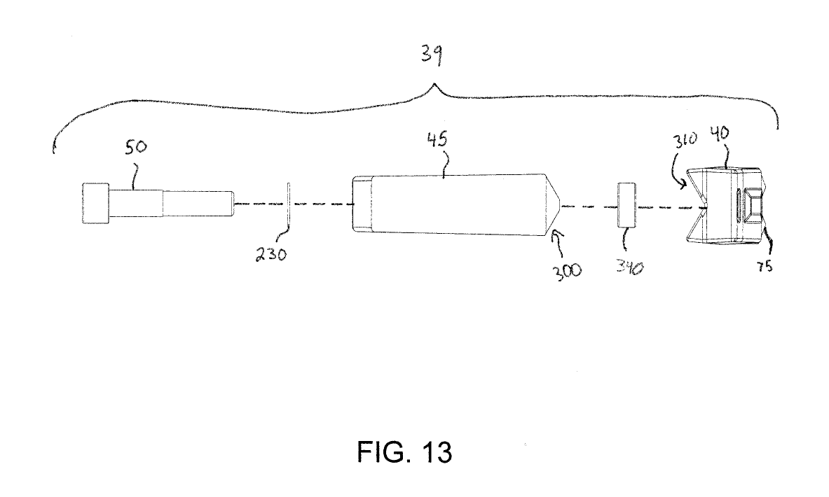

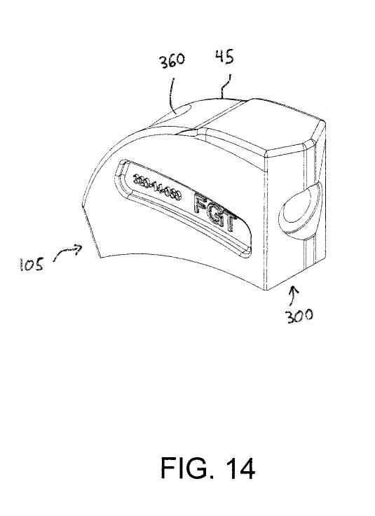

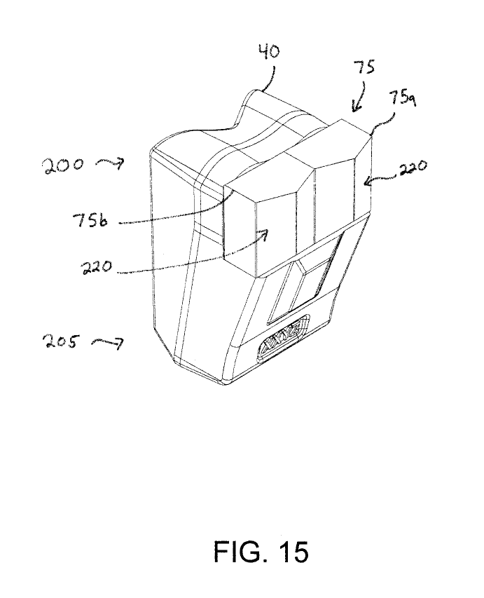

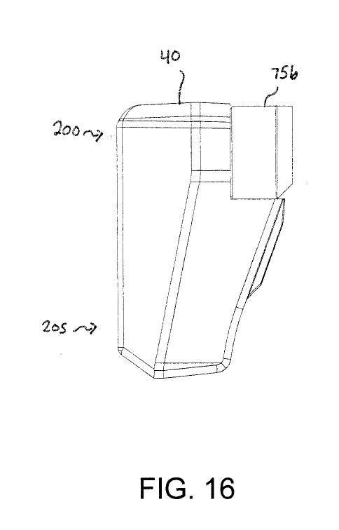

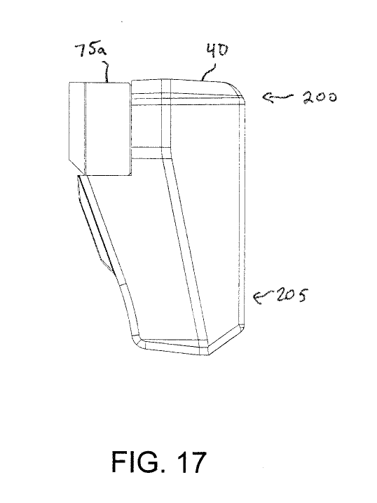

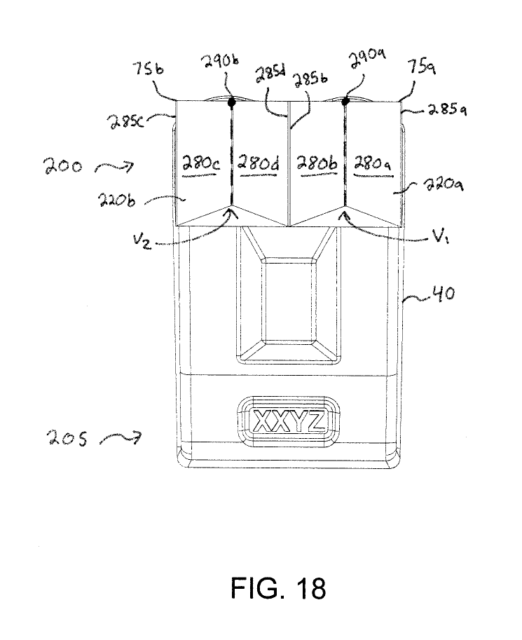

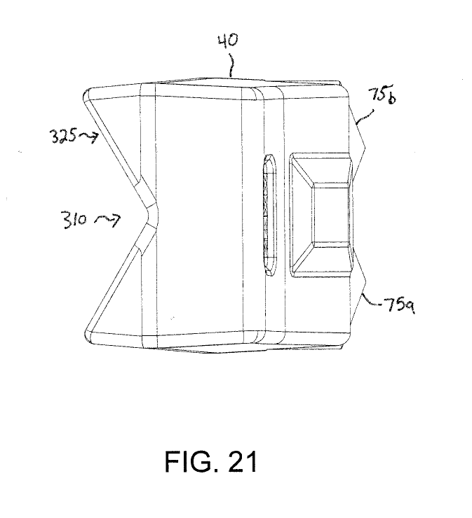

Referring to FIG. 9, one embodiment of a single cutting assembly 39 is shown. Additionally, FIGS. 10-13 depict exploded views of the cutting assembly 39, FIG. 14 depicts the tool holder 45 of the cutting assembly 39, and FIGS. 15-21 depict multiple views of the cutting tool 40 of the cutting assembly 39. The tool holder 45 may include a tool holder interface 300 on one end and a capture joint 105 at an end opposite the tool holder interface 300. The tool holder interface 300 may include a channel guide 340 that extends outwardly from the tool holder interface 300. In the embodiment shown, the channel guide 340 is cylindrical in shape and is a separate and distinct element of the cutting assembly 39 or the tool holder 45. In some embodiments, the tool holder 45 and the channel guide 340 are one integral or monolithic piece. Also, the capture joint 105 is constructed to engage and matingly receive the first end 36 of the depth control ring 35. As such, the tool holder 45 is slid onto or adjacent to the depth control ring 35 by inserting the first end 36 into or adjacent to the capture joint 105 of the tool holder 45. The tool holder 45 also may include a tool holder channel 360 that is disposed through the tool holder 45 from an opening adjacent to and above the capture joint 105 to an opening in the distal end of the channel guide 340. It is understood that the depth control ring 35 could be constructed such that its first end 36 is constructed to receive an end (opposite the tool holder interface 300) of the tool holder 45. It is also understood that the tool holder 45 may include more than one channel guide 340, tool holder channel 360, and openings. In additional, it is to be appreciated that the tool holder 45 may be constructed in a variety of other shapes, sizes, angles, and configurations.

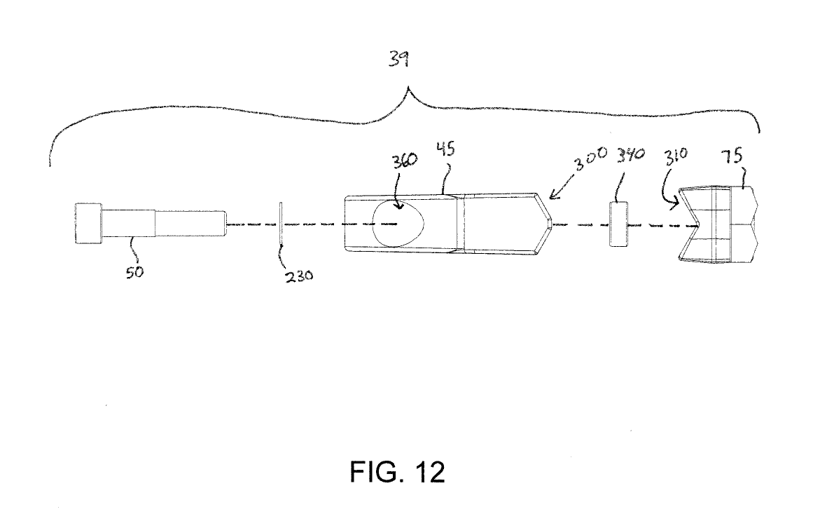

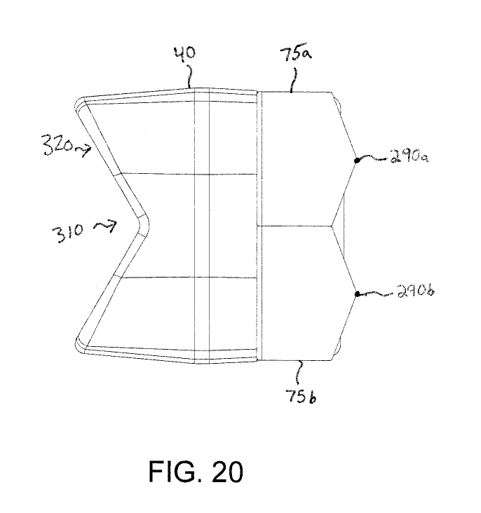

The tool holder interface 300 defines substantially a non-planar profile or surface that is constructed to provide a mating engagement with a cutting tool interface 310 of the cutting tool 40 in order to detachably mount or couple the cutting tool 40 onto the tool holder 45. In some examples, the nonplanar interfaces 300 and 310 are constructed such that all forces are driven to the center of the tool holder 45. In one example, the nonplanar profile of the interfaces 300 and 310 are substantially v-shaped in profile as shown, for example, in FIG. 12. As shown, the tool holder interface 300 includes an external v-shaped profile while the corresponding cutting tool interface 310 includes an internal v-shaped profile that matingly engages the tool holder interface 300. As an example, the tool holder interface 300 defines a generally “v” shape, non-planar profile that is generally convex in shape when viewed from an exploded top view as shown, for example, in FIG. 12. The cutting tool interface 310 defines a generally “v” shape, non-planar profile that is generally concave in shape when viewed from a top view as shown, for example, in FIG. 20.

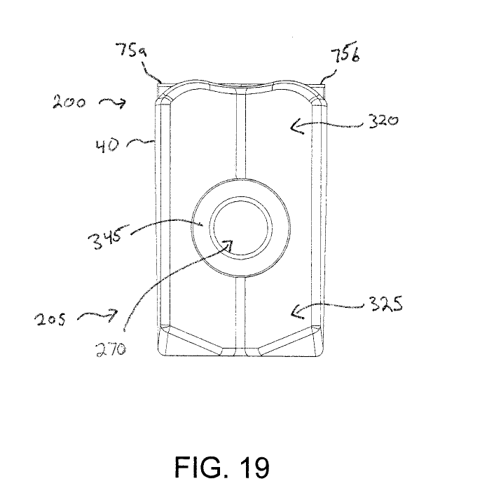

Accordingly, in order to mount the cutting tool 40 onto the tool holder 45, the nonplanar profile of the cutting tool interface 310 is matingly engaged with the corresponding nonplanar profile of the tool holder interface 300 and the channel guide 340 of the tool holder 45 is received within a channel pocket 345 disposed within the cutting tool interface 310. The channel pocket 345 may be constructed to receive a portion of or all of the channel guide 340. Referring specifically to FIG. 19, the cutting tool interface 310 may have an upper mating surface 320 and a lower mating surface 325. The upper mating surface 320 and the lower mating surface 325 may be constructed to provide sufficient enough space to permit the cutting tool 40 to slide over the channel guide 340 when inserting the cutting tool 40 into the tool holder 45.

The channel pocket 345 of the cutting tool interface 310 may connect with a center hole 270 that is disposed in this illustrative embodiment through a portion of the cutting tool 40 from the cutting tool interface 310 to an interior point of the cutting tool 40. When the cutting tool 40 is mounted onto the tool holder 45 and their respective interfaces 310 and 300 are matingly engaged, the tool holder channel 360 (and channel guide 340) is coaxially aligned with the center hole 270 (and the channel pocket 345) and both are constructed to receive the fastening device 50. Specifically, the inner diameter of the center hole 270 is threaded in order to threadingly receive and engage the fastening device 50, which in this illustrative embodiment, is an externally threaded bolt. In one embodiment, the tool holder channel 360 and the center hole 270 are coaxially aligned with a center tool axis (C). In the embodiment shown, a washer 230 may optionally be inserted into the tool holder channel 360 within the tool holder 45. The fastening device 50 is then inserted through the washer 230, into and through the tool holder channel 360 and into the center hole 270 of the cutting tool 40. The fastening device 50 includes, but is not limited to, screws, bolts, rivets, nails, rods, adhesives, welds, epoxy, any similar devices that mechanically and/or chemically joins or affixes two or more objects together, and/or any combinations thereof In some embodiments, the fastening device 50 may be a rod that is epoxied into place within the tool holder 45 and cutting tool 40.

In another embodiment, the center hole 270 is disposed completely through the cutting tool 40 from the cutting tool interface 310 to a material receiving face (e.g., a cutting surface 220) of the cutting tool 40. In such embodiment, one end of the center hole 270, opposite the cutting tool interface 310, may be constructed to receive and hold a threaded bolt while the other end of the center hole 270 (at the cutting tool interface 310) may be constructed to receive and hold a nut constructed to threadingly engage the threaded bolt. Alternatively, one end of the center hole 270 (at the cutting tool interface 310) may be constructed to receive a threaded bolt (or the fastening device 50) while the other end of the center hole 270 (opposite the cutting tool interface 310) may be constructed to receive and hold a nut constructed to threadingly engage the threaded bolt.

In the embodiment shown, for example, in FIGS. 15-21, the cutting tool 40 has an upper end 200 and a lower end 205. The upper end 200 includes a first tooth 75a and a second tooth 75b. As shown, the tooth 75a and the tooth 75b can be substantially similar to each other. The tooth 75a may include a first cutting surface 220a. In some embodiments, the first cutting surface 220a may “sweep” back and away from a leading vertex V1 to form a first side surface 280a and a second side surface 280b disposed on opposite sides of the leading vertex V1. The first side surface 280a and the second side surface 280b may extend back from the leading vertex V1 to a first outer edge 285a and a second outer edge 285b, respectively. The leading vertex V1 may be a sharp edge, a point, a rounded or smooth-curved edge or point, or any combination thereof In some embodiments, the leading vertex V1 may include an upper-most point 290a. As discussed in more detail below, the upper-most point 290a may be used in part to define the angle of the first cutting surface 220a.

The tooth 75b may include a second cutting surface 220b. In some embodiments, the second cutting surface 220b may “sweep” back and away from a leading vertex V2 to form a third side surface 280c and a fourth side surface 280d disposed on opposite sides of the leading vertex V2. The third side surface 280c and the fourth side surface 280d may extend back from the leading vertex V2 to a third outer edge 285c and a fourth outer edge 285d, respectively. The leading vertex V2 may be a sharp edge, a point, a rounded or smooth-curved edge or point, or any combination thereof In some embodiments, the leading vertex V2 may include an upper-most point 290b. As discussed in more detail below, the upper-most point 290b may be used in part to define the angle of the second cutting surface 220b. The cutting surfaces 220 are the first areas of contact between the cutting tool 40 and the substance being struck by the teeth 75a, 75b. It should be appreciated that, in some embodiments, the tooth 75a and the tooth 75b may have different configurations. In such cases, the tooth 75a and the tooth 75b may have different cutting surfaces 220.

Referring back to FIG. 6, the cutting surface(s) 220 of the cutting tool 40 may be variably angled relative the central shaft axis 25 of the BCR drum assembly 10. For example, in some embodiments, a leading vertex V (e.g., the leading vertex V1 and/or the leading vertex V2) of a cutting surface 220 of one of the teeth 75a, 75b may be angled relative to a vector 604 radially extending from the central shaft axis 25. For example, the angle 602 of the leading vertex V of the cutting surface 220 may be defined by the vector 604 radially extending from the central shaft axis 25 to a radially, outer-most point 290 of the leading vertex V of the tooth 75 and a line that runs from the radially, outer-most point 290 through at least a portion of the leading vertex V. It should be appreciated that, in some embodiments, the leading vertex V may be a single point or a plurality of points forming a line. It should also be appreciated that, in some embodiments, the point 290 may also be defined as the radially, outer-most edge, surface, and/or vertex of the tooth 75 (or teeth). In some embodiments, the angle 602 defined by the leading vertex V and the vector 604 may range from about −10 degrees to about 10 degrees. In another example, the angle 602 defined by the leading vertex V and the vector 604 may range from about −8 degrees to about 8 degrees. In one example, the angle 602 formed between the leading vertex V and the vector 604 is about 8 degrees. It should be appreciated that the pitch or angle of the cutting surface(s) 220 of the cutting tool 40 can also be varied by changing the angle or pitch of the tool holder interface 300, the angle or pitch of the cutting tool interface 310, or any other element or component of the BCR drum assembly 10.

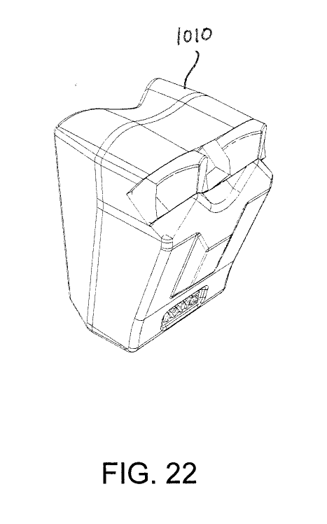

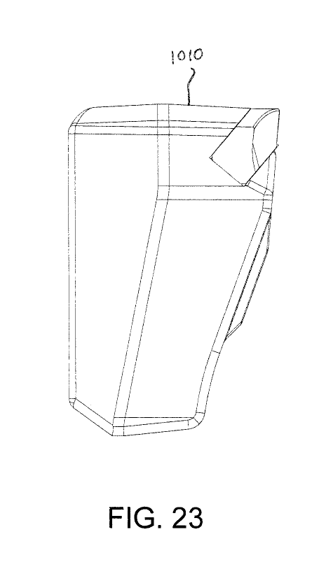

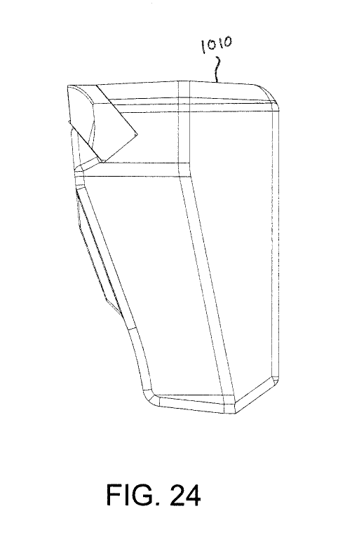

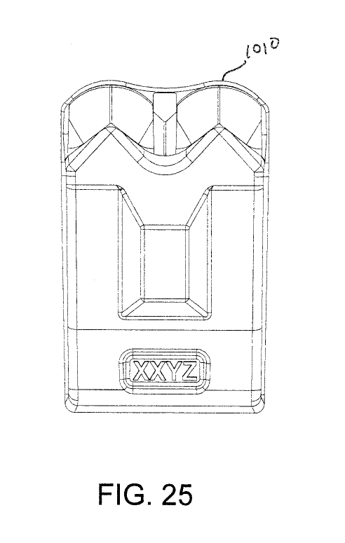

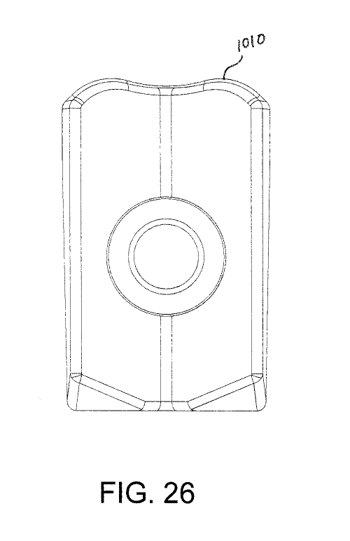

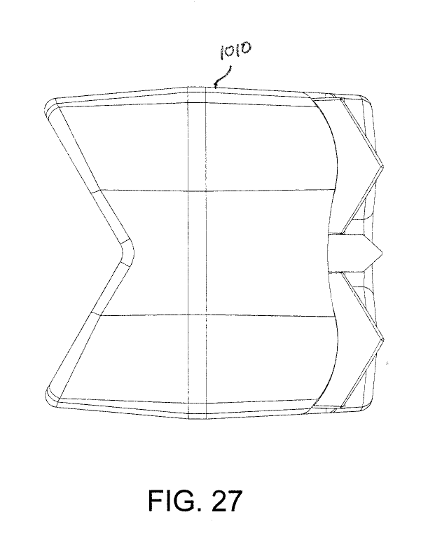

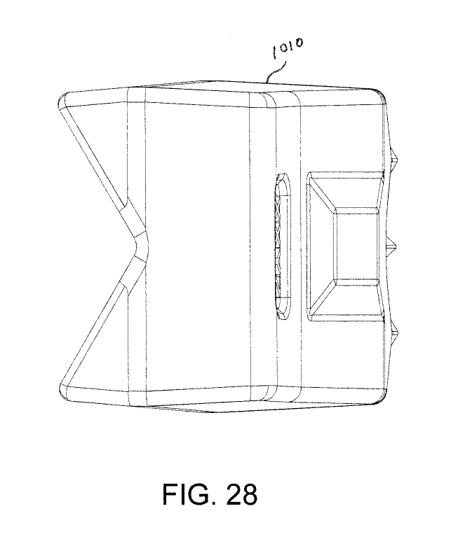

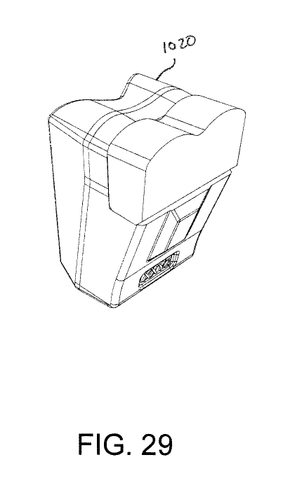

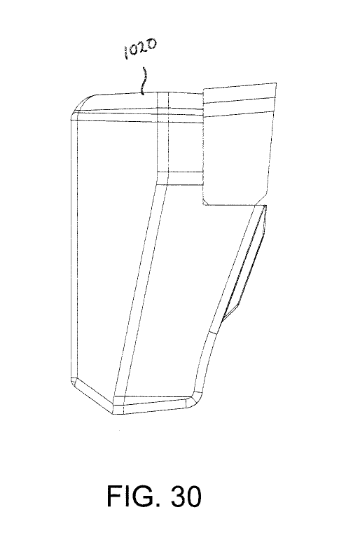

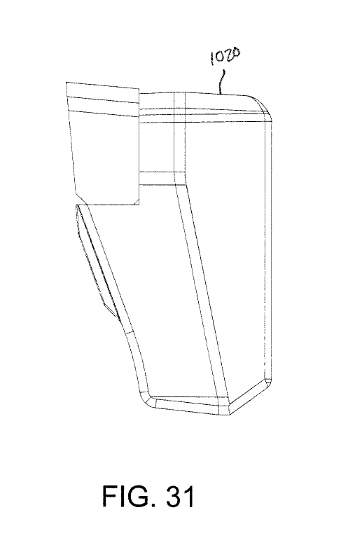

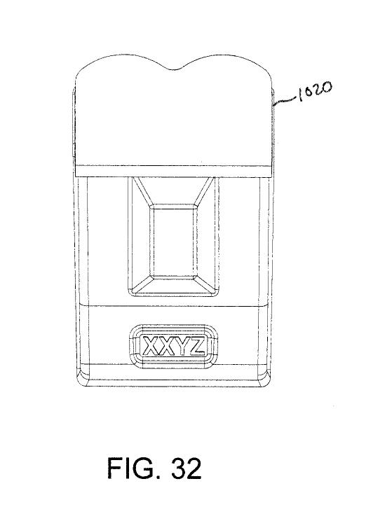

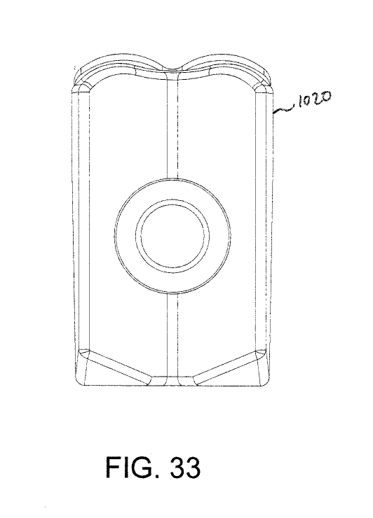

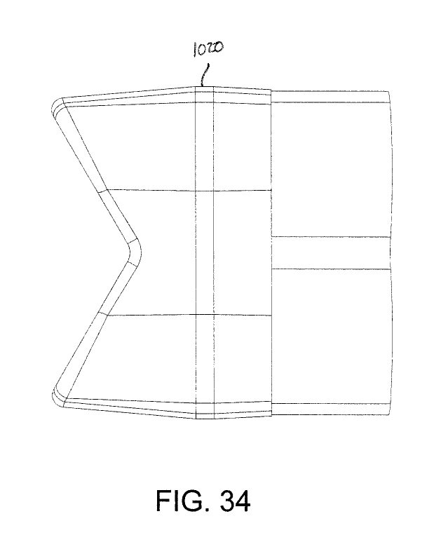

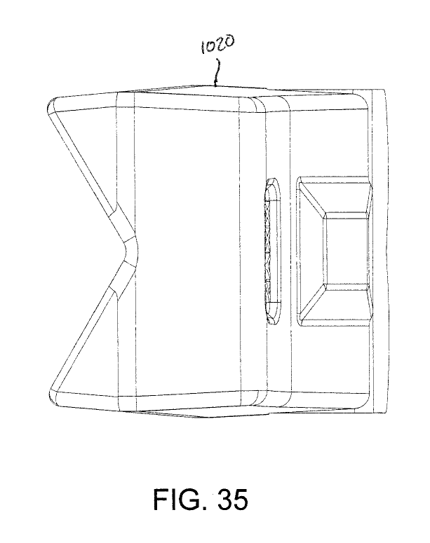

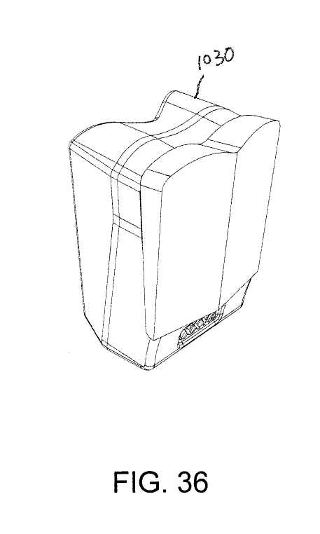

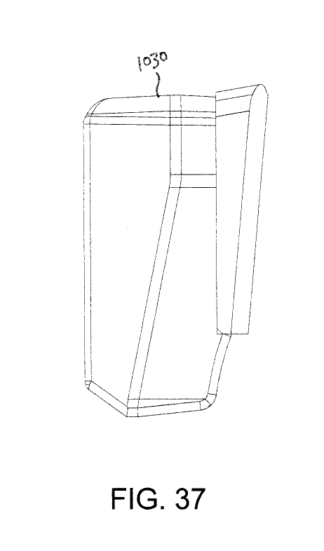

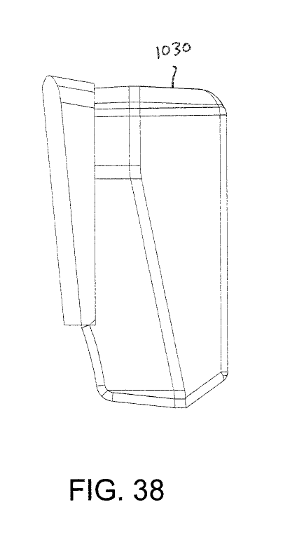

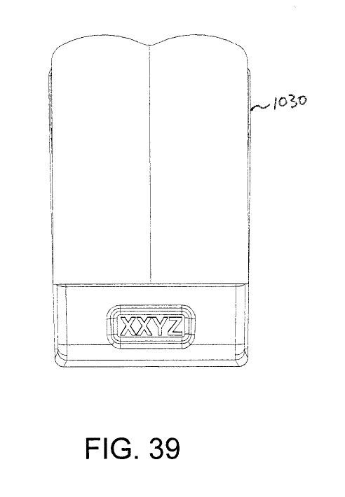

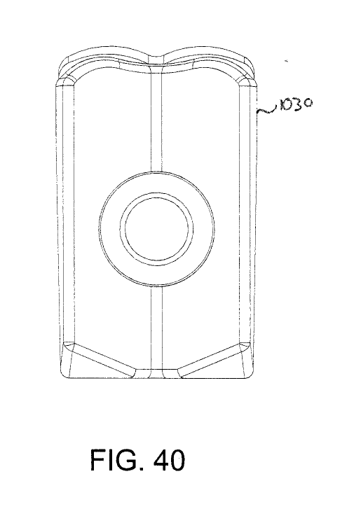

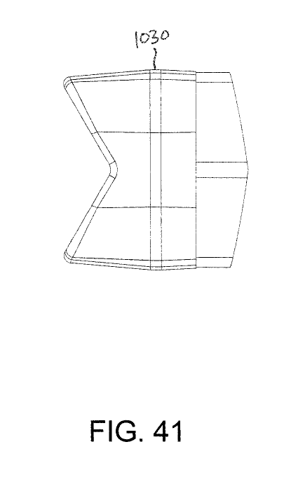

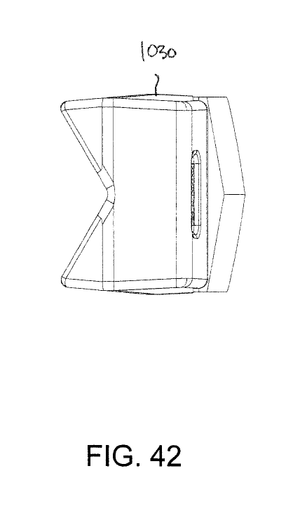

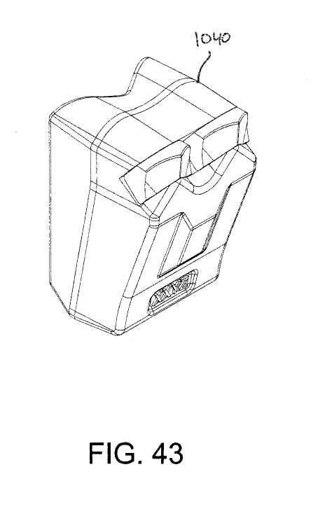

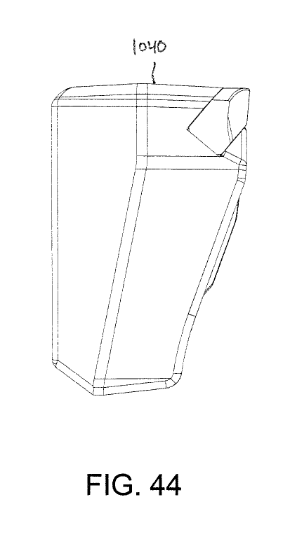

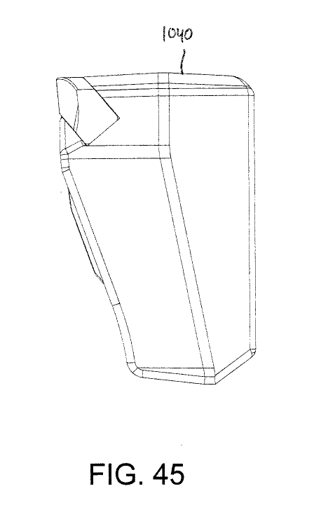

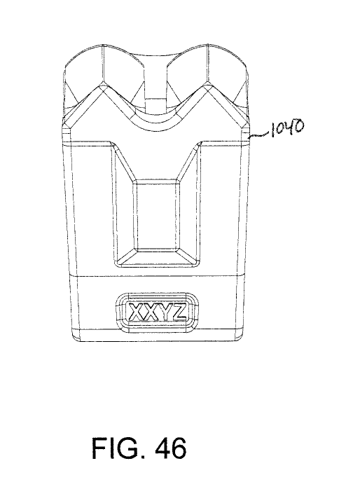

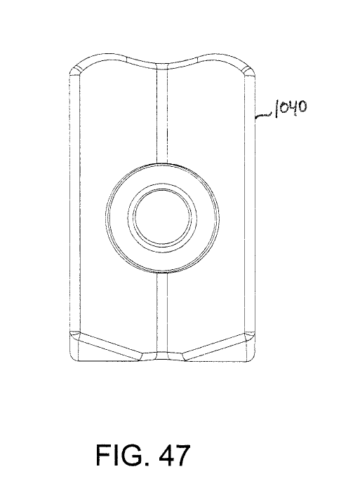

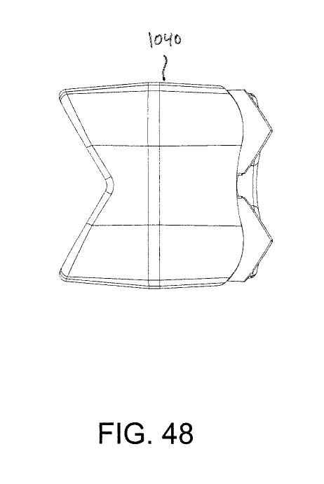

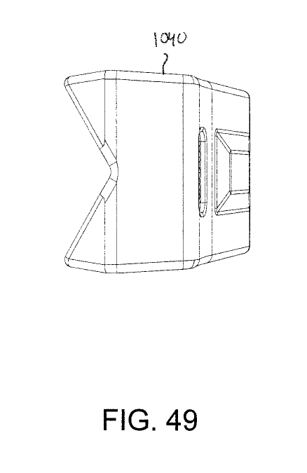

The cutting tool 40 and tool holder 45 and their respective interfaces may include the cutting tools, tool holders, and their respective interfaces as shown and described in commonly-owned U.S. Pat. No. 8,540,033, which is hereby incorporated by reference herein. It is also understood that other conventional or yet-to-be developed cutting tools and tool holders may be used with the BCR 900 and/or the BCR drum assembly 10. For example, the cutting tool 40 may be embodied as any one or a combination of the cutting tools 1010, 1020, 1030, 1040 illustratively shown in FIGS. 22-49. It should be appreciated that, in some embodiments, the cutting tools 1010, 1020, 1030, 1040 may include one or more features or characteristics (e.g., interfaces, angles, cutting surfaces, channels, materials, dimensions, etc.) that are substantially similar to the features or characteristics of the cutting tool 40 illustratively shown in FIGS. 15-21 and described above. Additionally, the cutting tool 40, tool holder 45, or any other element or component of the BCR 900 or the BCR drum assembly 10 may be made of carbide, carbon steel, stainless steel, or any other suitable compound or metal.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

Certain terminology is used in the disclosure for convenience only and is not limiting. The words “left”, “right”, “front”, “back”, “upper”, and “lower” designate directions in the drawings to which reference is made. The terminology includes the words noted above as well as derivatives thereof and words of similar import.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A bite control rotor assembly comprising:
a. a depth control ring having a first end, a second end opposite the first end, and a gap disposed between the first and second ends;
b. a tool holder having a capture joint and a tool holder interface opposite the capture joint, wherein the first end of the depth control ring is received within the capture joint; and
c. a cutting tool having a cutting tool interface and a cutting surface disposed on a side of the cutting tool opposite the cutting tool interface;
d. wherein the tool holder interface comprises a V-shaped surface and the cutting tool interface comprises a V-shaped surface that has a reciprocal shape to the tool holder interface such that the tool holder interface receives the cutting tool interface.

2. The bite control rotor assembly of claim 1, wherein the cutting surface is angled relative to a central axis associated with the bite control rotor assembly.

3. The bite control rotor assembly of claim 2, wherein the cutting surface comprises a leading vertex having a radially, outer-most point; and
wherein an angle of the cutting surface is defined by the angle formed between a vector extending radially from the central axis to the radially, outer-most point of the leading vertex and an imaginary line running from the radially, outer-most point of the leading vertex through at least a portion of the leading vertex.

4. The bite control rotor assembly of claim 3, wherein the angle formed between the vector and the imaginary line is between about −10 degrees and about 10 degrees.

5. The bite control rotor assembly of claim 3, wherein the angle formed between the vector and the imaginary line is between about −8 degrees and about 8 degrees.

6. The bite control rotor assembly of claim 3, wherein the angle formed between the vector and the imaginary line is about 8 degrees.

7. The bite control rotor assembly of claim 1, wherein the cutting surface comprises a leading vertex having a radially, outer-most point; and
wherein the cutting surface and the depth control ring cooperate to define a maximum depth of penetration, the maximum depth of penetration is defined as a first distance between the radially, outer-most point of the leading vertex and a circular plane defined by a peripheral edge of the depth control ring.

8. The bite control rotor assembly of claim 7, wherein the maximum depth of penetration is between about 0.25 inches and about 8 inches.

9. The bite control rotor assembly of claim 7, wherein the maximum depth of penetration is between about 1.5 inches and about 3 inches.

10. The bite control rotor assembly of claim 7, wherein the maximum depth of penetration is about 2 inches.

11. The bite control rotor assembly of claim 7, wherein the maximum depth of penetration is based at least in part on a depth height of the depth control ring.

12. The bite control rotor assembly of claim 7, wherein a depth height of the depth control ring is defined as a second distance measured from an inner diameter to an outer diameter of the depth control ring; and
wherein the depth height of the depth control ring is less than or equal to about half an overall height of the tool holder and the cutting tool.

13. A land clearing apparatus comprising:
a rotatable drum and a plurality of bite control rotor assemblies disposed on the rotatable drum; and
wherein each bite control rotor assembly comprises:
a. a depth control ring having a first end, a second end opposite the first end, and a gap disposed between the first and second ends;
b. a tool holder having a capture joint and a tool holder interface opposite the capture joint, wherein the first end of the depth control ring is received within the capture joint; and
c. a cutting tool having a cutting tool interface and a cutting surface disposed on a side of the cutting tool opposite the cutting tool interface;
d. wherein the tool holder interface comprises a V-shaped surface and the cutting tool interface comprises a V-shaped surface that has a reciprocal shape to the tool holder interface such that the tool holder interface receives the cutting tool interface.

14. The land clearing apparatus of claim 13, wherein each of the plurality of bite control rotor assemblies is equally spaced apart along a central shaft axis of the rotatable drum.

15. The land clearing apparatus of claim 13, wherein each of the plurality of bite control rotor assemblies is unequally spaced apart along a central shaft axis of the rotatable drum.

16. The land clearing apparatus of claim 13, wherein each bite control rotor assembly is rotationally positioned about a circumference of the rotatable drum out-of-phase a reference number of degrees relative to an adjacent bite control rotor assembly of the plurality of bite control rotor assemblies.

17. The land clearing apparatus of claim 13, wherein the cutting surface of each bite control rotor assembly comprises a leading vertex having a radially, outer-most point; and
wherein an angle of the cutting surface of each bite control rotor assembly is defined by the angle formed between a vector extending radially from a central axis of the rotatable drum to the radially, outer-most point of the leading vertex and an imaginary line running from the radially, outer-most point of the leading vertex through at least a portion of the leading vertex.

18. The land clearing apparatus of claim 17, wherein the angle formed between the vector and the imaginary line is between about −10 degrees and about 10 degrees.

19. The land clearing apparatus of claim 13, wherein the cutting surface of each bite control rotor assembly comprises a leading vertex having a radially, outer-most point; and
wherein the cutting surface and the depth control ring of each bite control rotor assembly cooperate to define a maximum depth of penetration of each bite control rotor assembly, the maximum depth of penetration is defined as a first distance between the radially, outer-most point of the leading vertex and a circular plane defined by a peripheral edge of the depth control ring.

20. The land clearing apparatus of claim 19, wherein the maximum depth of penetration of each bite control rotor assembly is between about 0.25 inches and about 8 inches.

21. The land clearing apparatus of claim 19, wherein the maximum depth of penetration of each bite control rotor assembly is based at least in part on a depth height of the depth control ring of each bite control rotor assembly.

22. The land clearing apparatus of claim 19, wherein a depth height of the depth control ring of each bite control rotor assembly is defined as a second distance measured from an inner diameter to an outer diameter of the depth control ring; and
wherein the depth height of the depth control ring of each bite control rotor assembly is less than or equal to about half an overall height of the tool holder and the cutting tool of each bite control rotor assembly.
